(19) United States
(12) Patent Application Publication
(10) Pub. No.: US 2012/0030564 A1
(43) Pub. Date: Feb. 2, 2012

(54) Domain-Specific Spell Check Overlays

(75) Inventors: Travis M. Grigsby, Austin, TX (US); Margaret Beth Morgan, Austin, TX (US); David Warren Zysk, Austin, TX (US)

(73) Assignee: International Business Machines Corporation, Armonk, NY (US)

(21) Appl. No.: 12/847,588

(22) Filed: Jul. 30, 2010

(51) Int. Cl. G06F 17/21

(52) U.S. Cl. 715/257

(57) ABSTRACT

The present invention provides a method, system, and program product for using a domain-specific spell check overlay. An overlay application determines a domain. The overlay application retrieving a domain-specific overlay for the domain, the domain-specific overlay comprising domain-specific modifications for a spell check word list. Then, the overlay application modifies the spell check word list according to the domain-specific overlay.

### FIELD OF THE INVENTION

The invention relates to the field of computer spell checking and more particularly to a method, system and computer program product for obtaining and using domain-specific spell check overlays.

### BACKGROUND

Many websites use jargon that is specific to a trade or social group. These words may not appear in a standard spell check word list used by a browser or word processing application for spell checking. Currently, a user can add terms to their personal custom word list, but this approach does not adjust for different web pages that a user may visit. Thus, the word list must be universal and unnecessarily long, reducing efficiency of use. Also, the possibility that a misspelling will match a word specific to another context increases with a universal word list.

### SUMMARY

It is advantageous for a spell check word list to adapt to the specific context in which it is being used.

According to one embodiment of the present invention, a method is provided for using a domain-specific spell check overlay to modify a spell check list for the context of a specific domain. An overlay application determines a domain and retrieves a domain-specific overlay for the domain. The domain-specific overlay comprises domain-specific modifications for a spell check word list. The overlay application then modifies the spell check word list according to the domain-specific overlay.

According to one embodiment the domain is at least one web page. The domain is identified by a client browser querying a web page for information to identify the domain-specific word list overlay. In one embodiment the client browser queries the web page using client side Uniform Resource Locator tracking to identify the domain.

According to one embodiment the overlay is removed when the client leaves the web page that identifies the domain for the word list overlay.

According to one embodiment the domain is the network address of the user. In this embodiment, the domain is determined by querying the computing device for a network address.

According to one embodiment the domain is specified by a user. The user may initiate the input of a domain by entering it through a menu or dialog box. Alternatively, the overlay application may prompt a user for a domain.

According to one embodiment the spell check overlay comprises words and domain identifiers associated with each word. The domain identifiers may specify words to be included in the spell check word list for the identified domains, and the domain identifiers may specify words to be excluded from the spell check word list for the identified domains.

According to one embodiment, a spell check application checks typed words against a spell check word list modified by a domain-specific overlay. The spell check application identifies typed words that do not match words in the modified spell check word list as misspelled words and presents suggested words from the modified spell check word list.

According to one embodiment the overlay is located on a third party memory in a third party computing device. The domain is determined by the overlay application retrieving a link to the domain-specific overlay.

According to one embodiment a system is provided for a domain-specific spell check overlay. The system comprises a processor and a client memory operably connected with the processor. An overlay application is encoded on the memory. The overlay application is executable by the processor to: determine a domain; retrieve a domain-specific overlay for the domain, the domain-specific overlay comprising domain-specific modifications for a spell check word list; and modify the spell check word list according to the domain-specific overlay.

According to one embodiment of the present invention, the overlay is encoded on the client memory. In this embodiment, the domain may be determined by querying the website or by the user specifying the domain.

According to another embodiment of the present invention a network connection operably connects the processor to a network server. The network server has a server memory, and the overlay is encoded on the server memory.

According to one embodiment of the present invention a web site is encoded on the server memory, and the overlay is encoded on the web site.

According to one embodiment of the present invention, a network connection operably connects the processor to a third party computing device through a network. The third party comuting device has a third party memory, and the overlay is encoded on the third party memory.

According to one embodiment of the present invention a program product is provided for using a domain-specific spell check overlay. The program product comprises a computer readable storage medium having encoded thereon a computer executable program of instruction. The program of instructions comprises: program instructions for determining a domain; program instructions for retrieving a domain-specific overlay for the domain, the domain-specific overlay comprising domain-specific modifications for a spell check word list; and program instructions for modifying the spell check word list according to the domain-specific overlay.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a system for using a domain-specific spell check overlay according to an embodiment of the present invention;

FIG. 2 is a flow diagram of a method for using a domain-specific spell check overlay according to an embodiment of the present invention;

FIG. 3 is a flow diagram of a method for loading a domain-specific overlay according to an embodiment of the present invention;

FIG. 4 is a flow diagram of a method for loading a domain-specific overlay according to an embodiment of the present invention;

FIG. 5 is a flow diagram of a method for loading a domain-specific overlay according to an embodiment of the present invention;

FIG. 6 is a method for removing a domain-specific overlay when the domain no longer applies according to an embodiment of the present invention; and

FIG. 7 is a diagram of a domain-specific spell check overlay used according to an embodiment of the present invention.

### DETAILED DESCRIPTION

The present invention provides a method, system and program product for using a domain-specific spell check overlay. According to an embodiment of the present invention, a browser identifies a domain comprising one or more websites on a network. An overlay is retrieved for the identified domain and a spell check word list is modified according to the overlay.

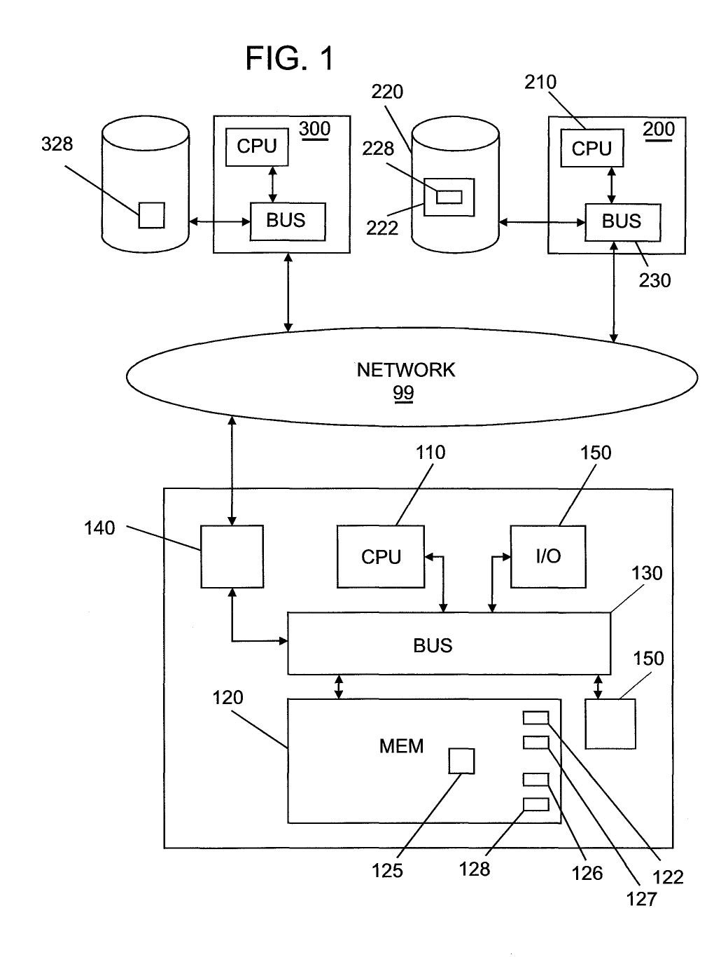

Referring to FIG. 1, a networked computing device 100, such as a personal computer, or the like, is connected to a network 99. The networked computing device 100 comprises a processor (CPU) 110 which executes computer program code to perform desired functions. The CPU may comprise hardware, software, or a combination thereof suitable for executing program code. According to an embodiment of the present invention, the CPU comprises one or more microprocessors.

A memory 120 is operably connected with the processor 110 through a system bus 130. The memory 120 may be one or more one or more memory devices. Also the memory may be a volatile memory device such as random access memory (RAM) or persistent memory device such as a hard drive, a flash memory, a CD-ROM, or the like, or a combination thereof.

The processor 110 executes programs of instruction encoded on memory 120. Data files used by the programs of instruction and created by the programs of instruction are also stored on memory 120.

Computing device 100 also comprises a network connection 140 for connecting the computing device to a network 99, such as the Internet. The network connection may be an Ethernet card, a wireless connection, or any other means for operably connecting a computing device to a network.

The computing device 100 may further comprise input/output devices 150 such as a keyboard, mouse, printer, and the like. The computing device 100 may still further comprise a monitor or display 150 for providing a user interface for the computing device.

Encoded on memory 120 are various applications. According to an embodiment of the invention, one of the applications encoded on memory 120 is a browser application 122 for searching the Internet for Websites and for connecting to desired websites. Another application encoded on memory 120 is a spell check application 124. The spell check application 124 compares words typed into one or more other applications with a spell check word list and identifies words which do not match any word from the spell check word list 125. Misspelled words (words that do not match any word in the spell check word list) may be identified in a variety of ways. For example, the misspelled word may be highlighted or underlined, or any other means for identification. Moreover, a misspelled word may be identified as it is written or when a spell check program is run. Also, a misspelled word may be replaced with a best match from a spell check word list. The spell check application 124 may be a part of another application or may be a stand-alone application. The spell check word list 125 may be a part of the spell check application 124 or may be a separate file.

The computing device 100 may be connected through the network 99 to a server 200 hosting one or more websites 222. The server 200 comprises a processor 210 operably connected to the network 99 through a system bus 230. A memory 220 is also operably connected to the processor 210 through the bus 230. The processor 210 may be any processing unit configured for processing code on the server 200, and in one embodiment comprises one or more microprocessors. The memory may be one or more of any data storage device integral to or external to the server 200 suitable for storing applications and/or data. Memory 220 may be volatile memory, persistent memory or a combination thereof. The processor 210 executes applications, such as websites 222 stored on the memory 220. A website may optionally comprise an integral overlay 228.

Third party computing devices 300 may also be operably connected to computing device 100 through network 99. The third party computing device 300 may optionally comprise an overlay 328 encoded on a memory operably connected to a processor.

According to an embodiment of the present invention, an overlay application 126 is also encoded on memory 120. The overlay application 126 determines a domain and retrieves a domain-specific overlay 128 for the domain. The domain-specific overlay 128 comprises domain-specific modifications for a spell check word list 125. The overlay application 126 then modifies the spell check word list 125 according to the domain-specific overlay 128.

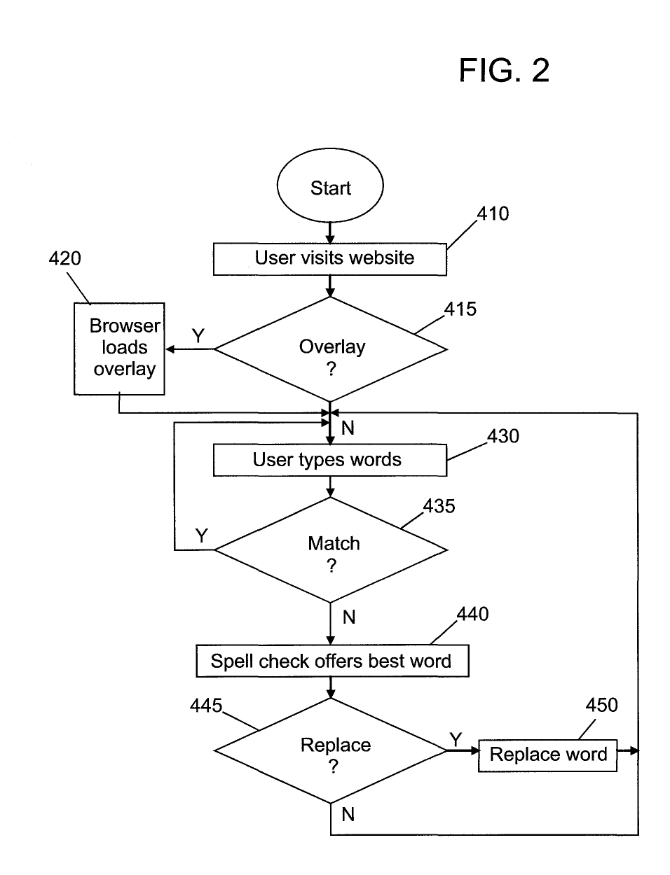

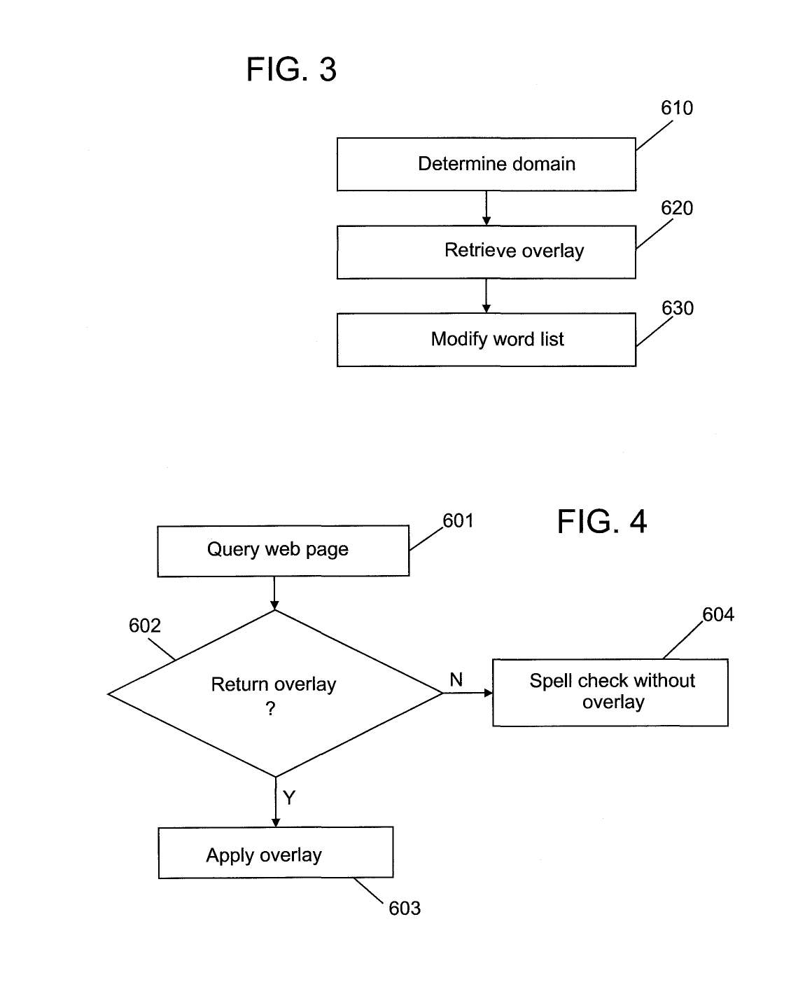

FIG. 2 is a flow diagram of a method for using a domain-specific spell check overlay according to an embodiment of the present invention. In this embodiment, a user visits a website or web page 222 from a server 200 through the Internet (step 410). To visit a website, the user runs a browser application 122 and enters a website or selects a website from a search.

The overlay application 126 determines whether or not an overlay is available for use with the website (step 415). This determination may be made in a variety of ways. According to one embodiment, a web page is defined as a domain, and the overlay application 126 searches for an overlay for that web site. According to one embodiment, overlays are stored on the memory 120 of the computing device 120 seeking to load the web page 222. The overlay 128 may be identified by the Uniform Resource Locator (URL) of the web page 222. When the URL is entered into the browser 122, the overlay application 126 intercepts the URL and searches for the matching overlay 128.

In another embodiment, the overlay 228 may be incorporated in the web page 222. In this embodiment, when the web page is loaded onto the client computing device 100, the overlay 228 is loaded on the client computing device 100 as part of the web page 222. In this embodiment, the overlay application 126 queries the web page 222 to determine whether or not an overlay 228 is present.

In another embodiment, the overlay 328 may be stored on a third party computing device 300, which may be a separate web page stored on another server, for example. In this embodiment, when the web page 222 is loaded onto the client computing device 100, the overlay application 126 queries the third party computing device for an overlay matching the URL of the loaded web page 222.

According to another embodiment, the determination of whether or not an overlay is available for the web page 222 requested by a browser application 122 is made by querying the web page for information to identify a domain-specific word list overlay. For example, the client browser 122 queries the web page 222 using client-side URL tracking to identify the domain. In client-side URL tracking a link to a URL comprises a query of one or more parameters, such as the referring site. In the present invention, a query may be used to identify the domain of the web page and/or whether or not an overlay is available for the web page.

In another embodiment, the domain is the network address of the user. This information is available to the user as is known in the art. In this embodiment, a user may use different words on his/her home computer and work computer. As in the previous examples, once the domain is determined, the overlay application 126 searches for a matching overlay 128, 228, 328 and loads the domain-specific overlay corresponding to the domain.

According to another embodiment, a user specifies a domain. In this embodiment, an overlay may be built for a key concept that has unique words associated with it, such as an on-line game, for example. The user may enter the domain into the overlay application 126, such as through a pull-down menu, dialog box, query from the application, or any other suitable means for entering data to an application. As in the previous examples, once the domain is determined, the overlay application 126 searches for a matching overlay 128, 228, 328 and loads the domain-specific overlay corresponding to the domain.

If a domain-specific overlay 128, 228, 328 is found, then it is loaded by the overlay application 126 (step 420). According to an embodiment of the present invention, loading the domain-specific overlay comprises modifying an existing spell check word list 125 with word and context entries from the overlay. According to one embodiment of the present invention, the spell check word list 125 comprises entries each comprising a word. The entries may also comprise one or more context indicators. The context indicators may each define a context (domain or group of domains) in which the word in the entry may be used or may be excluded. The word entries may also indicate the type of speech and whether or not it conjugates normally (e.g., a regular verb) eliminating the need for separate listings for different verb tense and the like.

The spell check application 124 then spell checks words entered by a user using the modified spell check word list. As a user types words into an application using spell check (step 430), the spell check application 124 compares the typed words to the modified spell check word list (step 435). If a typed word matches an entry in the modified spell check word list, then the spell check application continues matching with the next word (step 425).

If the typed word does not match an entry in the modified spell check word list (i.e., misspelled word), then the spell check application may optionally offer one or more close match words from the modified spell check word list (step 440). The spell check application 124 determines whether or not to replace the misspelled word (step 445). This may be accomplished by querying the user, or by testing the goodness of the match, for example. If, the spell check application determines that the misspelled word should be replaced, then it is replaced with a designated alternate in the document or application entry in which the word was typed (step 450) and the spell check application continues with the next word (step 430). If the spell check application 124 determines that the misspelled word should not be replaced, then the misspelled word is left in the document or application entry in which it was typed, and the spell check application 124 continues with the next word (step 430).

If, at step 415, no domain-specific overlay is available, then the spell check application proceeds with an unmodified spell check list 125.

FIG. 33 is a flow diagram of a method for loading a domain-specific overlay according to an embodiment of the present invention. In this embodiment, the overlay application 126 determines an appropriate domain (step 610). The domain may be a web site or group of web sites; a concept or subject area, such as an on-line game, field of business or the like; or a web address of the user's computing device. The domain may be input by the user, extracted from a URL, retrieved using URL tracking, or any other means appropriate for the particular domain.

The overlay application 126 retrieves a domain-specific overlay 128, 228, 328 corresponding to the domain in which words are being written (step 620). As previously described, the overlay 128, 228, 328 may be stored in the user's computing device 100, the web page server 200, or a third party computing device 300 in various embodiments. The overlay application may search one or more of these locations for an overlay according to the particular embodiment.

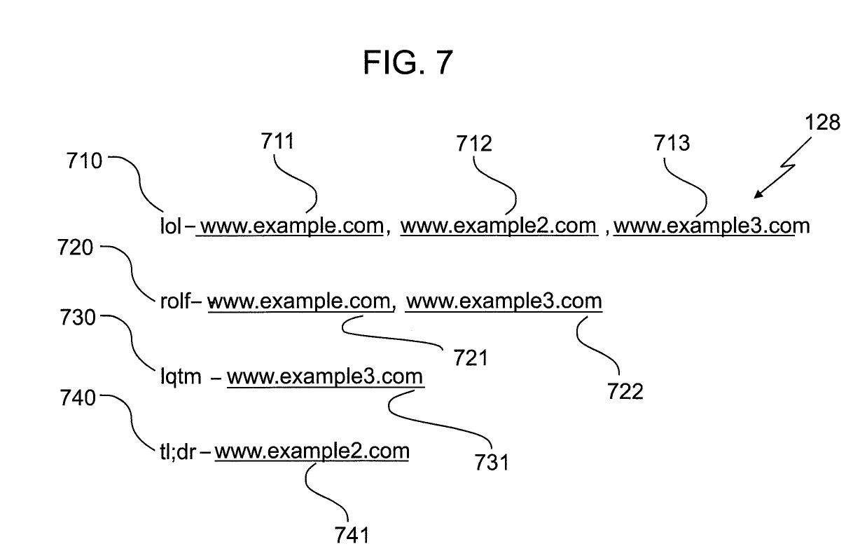

The overlay application 126 then modifies an existing spell check word list 125 according to entries in the domain-specific overlay 128, 228, 328. As shown in FIG. 7, according to one embodiment, the overlay entries comprise words 710, 720, 730, 740 and context identifiers 711, 712, 713, 721, 722, 731, 741, which may indicate that a word should be added for a specific domain (as shown) or that a word should be removed for a specific domain (not shown).

FIG. 4 is a flow diagram of a method for loading a domain-specific overlay according to an embodiment of the present invention. In this embodiment, overlays 228 are stored on the web site server 200, and more particularly, on the web site 222. The overlay application 126 queries the web site for an overlay (step 601). The web site 222 returns a web site specific overlay 228 if one is available.

The overlay application determines whether or not an overlay is returned by the web site (step 602). If the web site returns an overlay 228, the overlay application 126 applies the overlay 228 by modifying an existing spell check word list 125 according to entries in the domain-specific overlay 228 (step 603). If an overlay 228 is not returned by the web site 222, then the spell check application 124 spell checks typed words using the existing spell check word list 125 without modification (step 604).

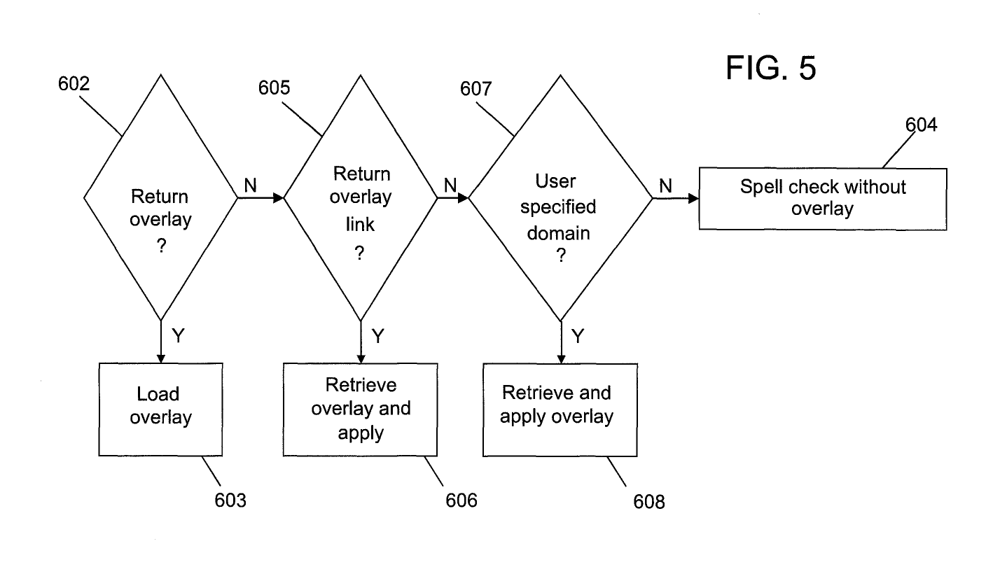

FIG. 5 is a flow diagram of a method for loading a domain-specific overlay according to an embodiment of the present invention. In this embodiment the overlay application 126 searches for a matching domain specific overlay 128, 228, 328 in each possible location: the user's computing device 100, the web site 222, and a third party computing device 300. It should be understood, however, that embodiments are contemplated in which one location is searched and that each of the three locations may be the one location.

The overlay application 126 determines whether or not the web site has returned a matching domain-specific overlay 228 (step 602). If the web site returns an overlay 228, then the overlay is loaded as previously described (step 603). If an overlay is not received, then the overlay application 126 determines whether or not a link has been provided by the web site 222 to a domain-specific overlay on a third party computing device 300 (step 605). It should be noted that in this embodiment the web site provides a link to a third party overlay 328. It is also possible however, for an embodiment in which the link to a third party overlay 328 is provided directly to the overlay application 126 by a user.

If a link is provided to a third party overlay 328, then the third party overlay 328 is retrieved and loaded to the overlay application 126 to modify the spell check word list 125 (step 606). If a link is not provided, the overlay application determines whether or not a user specified domain 128 has been designated (step 607). If a user specified domain 128 has been designated, then the user specified domain is retrieved and loaded by the overlay application 126 (step 608). If no user specified domain is provided, then the spell check application 124 checks the spelling of typed words with an unmodified spell check word list 125.

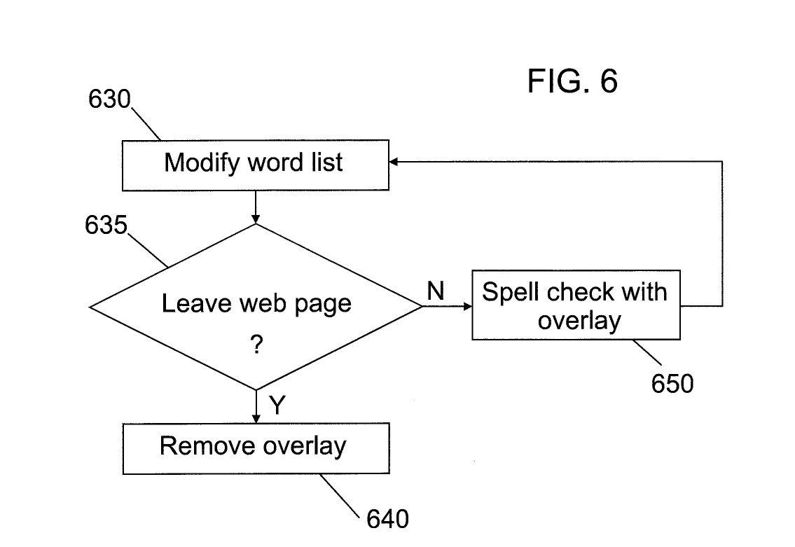

FIG. 6 is a method for removing a domain-specific overlay when the domain no longer applies according to an embodiment of the present invention. The overlay application 126 modifies the word list 125 according to entries in the domain specific overlay 128, 228, 328 (step 630). The overlay application determines whether or not the user has left the web site 222 of the domain specific overlay 128, 228, 328 (step 635). This may be accomplished by monitoring the status of the browser 122, for example. If the user has left the web site 222 corresponding to the loaded domain-specific overlay 128, 228, 328, then the overlay application 126 removes the overlay 128, 228, 328 (step 640). The overlay is removed by backing out the modifications made by the overlay. If the user has not left the web site corresponding to the domain-specific overlay 128, 228, 328, then the spell check application 124 continues to check typed words using the modified spell check word list (step 650).

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain or store the program for use by or in connection with the instruction execution system, apparatus, or device.

The foregoing method may be realized by a program product comprising a machine-readable medium having a machine-executable program of instructions stored on it, which when executed by a machine, such as a computer, performs the steps of the method. This program product may be stored on any of a variety of known machine-readable storage mediums, including but not limited to compact discs, floppy discs, USB memory devices, and the like.

The storage medium can be an electronic, magnetic, optical, electromagnetic, infrared, or semiconductor system (or apparatus or device). Examples of a computer-readable storage medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

What is claimed is:

1. A method for using a domain-specific spell check overlay, comprising:
determining a domain;
retrieving a domain-specific overlay for the domain, the domain-specific overlay comprising domain-specific modifications for a spell check word list; and
modifying the spell check word list according to the domain-specific overlay.

2. The method of claim 1, wherein the domain is at least one web page identified by a client browser querying a web page for information to identify the domain-specific word list overlay.

3. The method of claim 2, wherein the client browser queries the web page using client side Uniform Resource Locator tracking to identify the domain.

4. The method of claim 2, wherein the overlay is removed when the client leaves the web page.

5. The method of claim 1, wherein the domain is the network address of the user.

6. The method of claim 1, wherein the domain is specified by a user.

7. The method of claim 1, wherein the spell check overlay comprises words and domain identifiers associated with the words.

8. The method of claim 1, wherein the associated domain identifiers specify words to be included in the spell check word list for the identified domains.

9. The method of claim 1, wherein the associated domain identifiers specify words to be excluded from the spell check word list for the identified domains.

10. The method of claim 1, further comprising:
checking typed words against the spell check word list modified by the domain-specific overlay;
identifying typed words that do not match words in the modified spell check word list as misspelled words; and
in response to identifying misspelled words, presenting suggested words from the modified spell check word list.

11. The method of claim 1, wherein the domain is determined by the overlay application retrieving a link to the domain-specific overlay.

12. A system for a domain-specific spell check overlay, comprising:
a processor; and
a client memory operably connected with the processor and having encoded thereon an overlay application, the overlay application executable by the processor to:
determining a domain;
retrieving a domain-specific overlay for the domain, the domain-specific overlay comprising domain-specific modifications for a spell check word list; and
modifying the spell check word list according to the domain-specific overlay.

13. The system of claim 12, wherein the overlay is encoded on the client memory.

14. The system of claim 12, further comprising a network connection operably connecting the processor to a network server, the network server having a server memory, and the overlay being encoded on the server memory.

15. The system of claim 14, wherein a web site is encoded on the server memory, and the overlay is encoded on the web site.

16. The system of claim 12, further comprising a network connection operably connecting the processor to a third party computing device having a third party memory, the overlay being encoded on the third party memory.
Browser.

17. A program product for using a domain-specific spell check overlay, comprising a computer readable storage medium having encoded thereon a computer executable program of instruction comprising:
program instructions for determining a domain;
program instructions for retrieving a domain-specific overlay for the domain, the domain-specific overlay comprising domain-specific modifications for a spell check word list; and
program instructions for modifying the spell check word list according to the domain-specific overlay.
